(19) United States
(12) Patent Application Publication
(10) Pub. No.: US 2019/0358871 A1
(43) Pub. Date: Nov. 28, 2019

(54) METHOD OF PRODUCING VIBRATION DAMPING AND SOUND ABSORBING FOAM

(71) Applicant: Sumitomo Riko Company Limited, Komaki-shi (JP)

(72) Inventors: Kunio Ito, Komaki-shi (JP); Motoshige Hibino, Komaki-shi (JP); Takahiro Kachi, Komaki-shi (JP); Shinsuke Asai, Komaki-shi (JP); Keiichi Muratani, Komaki-shi (JP)

(73) Assignee: Sumitomo Riko Company Limited, Komaki-shi (JP)

(21) Appl. No.: 16/532,922

(22) Filed: Aug. 6, 2019

Related U.S. Application Data
(63) Continuation of application No. PCT/JP2018/047542, filed on Dec. 25, 2018.

(30) Foreign Application Priority Data
Dec. 27, 2017 (JP) 2017-250736

(51) Int. Cl. B29C 44/56

(52) U.S. Cl. CPC B29C 44/5618; B29K 2075/00; B29C 44/5627

(57) ABSTRACT

Vibration damping and sound absorbing foam formed of foam and fine particles present inside the foam so as to form bell-like structures having communication paths to a surface of the foam is produced by performing the following steps [I] to [III] in the stated order. [I] Preparing foam having foamed cells inside the foam and having communication paths to the foamed cells on a surface thereof, and fine particles each having a particle diameter smaller than a cell diameter of each of the foamed cells and larger than a diameter of each of the communication paths. [II] Swelling the foam to enlarge the diameter of each of the communication paths, and then sprinkling the surface of the foam with the fine particles, followed by pushing of the fine particles into the foamed cells via the communication paths with a fluid pressure of a liquid. [III] Drying the foam.

### RELATED APPLICATION

This application is a continuation of International Application No. PCT/JP2018/047542, filed on Dec. 25, 2018, which claims priority to Japanese Patent Application No. 2017-250736, filed on Dec. 27, 2017, the entire contents of each of which being hereby incorporated by reference.

### TECHNICAL FIELD

The present disclosure relates to a method of producing vibration damping and sound absorbing foam, and more specifically, to a method of producing vibration damping and sound absorbing foam to be used as, for example, vibration damping and sound absorbing foam for housing, vibration damping and sound absorbing foam for an automobile, vibration damping and sound absorbing foam for Office Automation equipment, vibration damping and sound absorbing foam for a railroad, or vibration damping and sound absorbing foam for a road or a bridge.

Hitherto, in a housing building, transmission of sounds between upper and lower floors has been perceived as a problem. The sounds to be perceived as a problem in the housing building are generated from various sources, and hence it is difficult to take a countermeasure against all the sounds through use of one member. Therefore, in general, members specialized in reducing sounds in respective frequency regions are used in combination in order to carry out a countermeasure against all audible regions. For example, in a low-frequency region of from 10 Hz to 1,000 Hz, a sound reducing effect exhibited by a sound absorbing material is low, and hence a vibration countermeasure is mainly carried out. In a high-frequency region of 1,000 Hz or more, a sound countermeasure based on a sound absorbing material or a sound insulating material is carried out.

Specific examples of the vibration countermeasure include (1) an increase in rigidity of a building frame, (2) an increase in weight of concrete or the like, (3) placement of an anti-vibration rubber that does not transmit vibration, and (4) mounting of a vibration damping material.

Meanwhile, specific examples of the sound reducing countermeasure based on a sound absorbing material or a sound insulating material include (1) attachment of a sound insulating sheet, (2) placement of a box configured to confine sound, and (3) application of glass wool.

In general, a countermeasure in the housing building is taken by taking a vibration countermeasure and a sound countermeasure based on a combination of the above-mentioned various members.

Incidentally, in recent years, as a member for taking both of the vibration countermeasure and sound countermeasure as described above, there has been proposed a sound insulating plate or the like having many internal closed pores and having bell-like structures including, in the pores, inorganic fine particles that can independently move (see PTL 1 and PTL 2).

### RELATED ART DOCUMENT

### Patent Document

PTL 1: JP-B2-2818862

PTL 2: JP-A-2006-335918

### SUMMARY

The sound insulating plate having the bell-like structures as described above provides a certain vibration damping effect on the basis of: a vibration damping effect based on vibration and collision of the inorganic fine particles in the pores (impact damper effect); and a vibration damping effect based on the deformation of a resin or the like forming the sound insulating plate caused by the weight of the inorganic fine particles (mass damper effect). In addition, when the sound insulating plate is made of foam, a certain sound absorbing effect is also provided. Thus, the sound insulating plate having the bell-like structures as described above is recognized as exhibiting certain effects as a member for taking both of a vibration countermeasure and a sound countermeasure.

However, in each of PTL 1 and PTL 2 described above, the bell-like structures are formed by coating the surfaces of the inorganic fine particles with a foaming agent, and then mixing the inorganic fine particles into the resin serving as a material for the sound insulating plate, followed by foaming of the foaming agent on the surfaces of the inorganic fine particles, and hence it is difficult to adjust pore diameters in the bell-like structures. Accordingly, in such production method, it is difficult to form uniform bell-like structures, and the difficulty poses an obstacle in achieving both of a vibration countermeasure and a sound countermeasure.

Meanwhile, when the inorganic fine particles are merely mixed into the material for the foam, the bell-like structures as described above are not successfully formed. Accordingly, it is difficult to achieve both of a desired vibration countermeasure and a desired sound countermeasure by this technique.

The present disclosure has been made in view of such circumstances, and provides a method of producing vibration damping and sound absorbing foam by which vibration damping and sound absorbing foam capable of achieving both of a vibration countermeasure and a sound countermeasure, and capable of taking a countermeasure against sounds ranging widely from a low frequency to a high frequency can be satisfactorily produced.

The gist of the present disclosure relates to a method of producing vibration damping and sound absorbing foam formed of foam and fine particles present inside the foam so as to form bell-like structures having communication paths to a surface of the foam, the method including the following steps [I] to [III] in the stated order:

[I] a step of preparing foam having foamed cells present inside the foam and having communication paths to the foamed cells on a surface thereof, and fine particles each having a particle diameter smaller than a cell diameter of each of the foamed cells and larger than a diameter of each of the communication paths;

[II] a step including swelling the foam with at least one liquid selected from water and a solvent to enlarge the diameter of each of the communication paths so that the diameter of each of the communication paths becomes larger than the particle diameter of each of the fine particles, and then sprinkling the surface of the foam with the fine particles, followed by pushing of the fine particles into the foamed cells via the communication paths through use of a fluid pressure of at least one liquid selected from water and a solvent; and

[III] a step of drying the foam.

The inventors have made extensive investigations in order to solve the above-mentioned problem. In the course of the investigations, the inventors have obtained the following finding: When, instead of the bell-like structures in which fine particles are present inside closed pores, fine particles are caused to be present inside foam so as to form bell-like structures having communication paths communicating to a surface of the foam, and besides, the bell-like structures are uniformly formed, both of a vibration countermeasure and a sound countermeasure are satisfactorily achieved. Then, the inventors have made extensive investigations on a production method by which vibration damping and sound absorbing foam having such bell-like structures can be satisfactorily produced. As a result, the inventors have found such a production method as described below. That is, first, foam having uniform foamed cells present inside the foam and having communication paths to the foamed cells on a surface thereof is prepared. Then, the foam is swollen with a liquid, such as water, to enlarge the diameter of each of the communication paths, and then the surface of the foam is sprinkled with fine particles, followed by pushing of the fine particles into the foamed cells via the communication paths, which have been caused to have enlarged diameters as described above, through use of the fluid pressure of a liquid, such as water. Finally, the foam is dried to reduce the diameter of each of the communication paths. The inventors have found that, in the thus obtained vibration damping and sound absorbing foam, uniform bell-like structures are easily formed by specifying the foamed cell diameter of the foam serving as a material therefor and specifying the particle diameter of each of the fine particles, and as a result, the desired object can be achieved.

As described above, the method of producing vibration damping and sound absorbing foam of the present disclosure includes in this order: the step of preparing foam having foamed cells present inside the foam and having communication paths to the foamed cells on a surface thereof, and fine particles each having a particle diameter smaller than a cell diameter of each of the foamed cells and larger than a diameter of each of the communication paths (step [I]); the step including swelling the foam with at least one liquid selected from water and a solvent to enlarge the diameter of each of the communication paths so that the diameter of each of the communication paths becomes larger than the particle diameter of each of the fine particles, and then sprinkling the surface of the foam with the fine particles, followed by pushing of the fine particles into the foamed cells via the communication paths through use of a fluid pressure of at least one liquid selected from water and a solvent (step [II]); and the step of drying the foam (step [III]). Accordingly, the vibration damping and sound absorbing foam that has bell-like structures having communication paths communicating to the surface of the foam and that is capable of taking a countermeasure against sounds ranging widely from a low frequency to a high frequency can be satisfactorily produced.

In particular, when a material for the foam to be used includes at least one of ether polyurethane and ester polyurethane, the vibration damping and sound absorbing foam for taking both of a vibration countermeasure and a sound countermeasure can be more satisfactorily produced.

In addition, when the fine particles to be used include at least one selected from the group consisting of inorganic fine particles, metal fine particles, and resin fine particles, the vibration damping and sound absorbing foam for taking both of a vibration countermeasure and a sound countermeasure can be more satisfactorily produced.

Further, when the liquid to be used includes a solvent having a boiling point of 150° C. or less, the swelling and drying of the foam are facilitated, and hence the vibration damping and sound absorbing foam for taking both of a vibration countermeasure and a sound countermeasure can be more satisfactorily produced.

In addition, when the method further includes, before the step [I], a step of blowing air against the surface of the foam to crush the foam, the openings of the communication paths to the foamed cells are likely to appear on the surface of the foam, and hence the step [II] can be more favorably performed.

### BRIEF DESCRIPTION OF DRAWINGS

FIG. 1 is an explanatory view for schematically illustrating bell-like structures in vibration damping and sound absorbing foam according to the present disclosure.

FIG. 2 is a scanning electron microscope (SEM) photograph of a cross-section of a sample of the vibration damping and sound absorbing foam according to the present disclosure, and is a photograph of such bell-like structures that fine particles are contained in the foam.

FIG. 3 is an explanatory view for illustrating a step of pushing fine particles into foamed cells of foam.

### DESCRIPTION OF EMBODIMENTS

Next, embodiments of the present disclosure are specifically described.

A method of producing vibration damping and sound absorbing foam of the present disclosure includes in this order: a step of preparing foam having foamed cells present inside the foam and having communication paths to the foamed cells on a surface thereof, and fine particles each having a particle diameter smaller than a cell diameter of each of the foamed cells and larger than a diameter of each of the communication paths (step [I]); a step including swelling the foam with at least one liquid selected from water and a solvent to enlarge the diameter of each of the communication paths so that the diameter of each of the communication paths becomes larger than the particle diameter of each of the fine particles, and then sprinkling the surface of the foam with the fine particles, followed by pushing of the fine particles into the foamed cells via the communication paths through use of a fluid pressure of at least one liquid selected from water and a solvent (step [II]); and a step of drying the foam (step [III]). Accordingly, vibration damping and sound absorbing foam that has bell-like structures having communication paths communicating to the surface of the foam, that is capable of achieving both of a vibration countermeasure and a sound countermeasure, and that is capable of taking a countermeasure against sounds ranging widely from a low frequency to a high frequency can be satisfactorily produced.

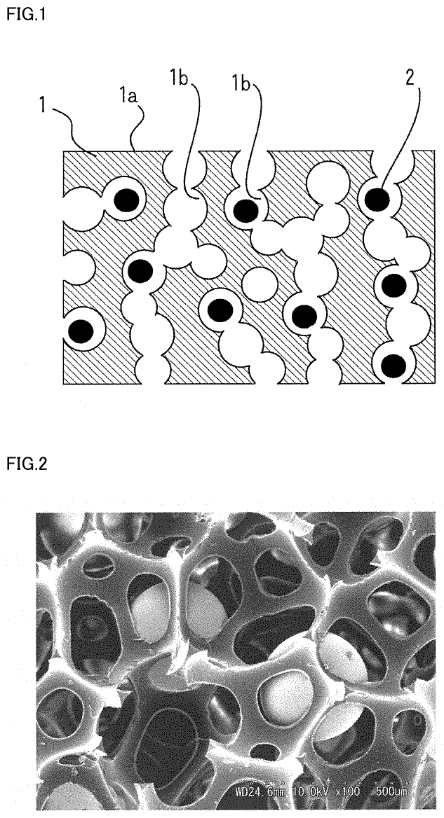

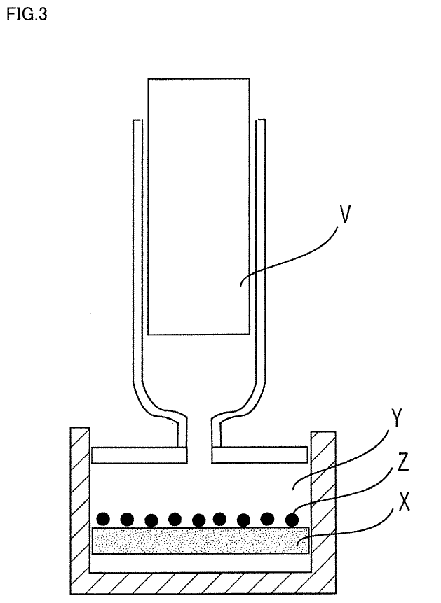

When schematically illustrated, the bell-like structures in the vibration damping and sound absorbing foam are as illustrated in FIG. 1. In FIG. 1, reference symbol 1 denotes foam, reference symbol 1a denotes a foam surface, reference symbol 1b denotes a foamed cell, and reference symbol 2 denotes a fine particle. In addition, such bell-like structures may be identified by, for example, observing a cross-section of the vibration damping and sound absorbing foam with a scanning electron microscope (SEM). FIG. 2 is an actual scanning electron microscope (manufactured by Hitachi, Ltd., SEMEDX TYPE N, magnification: 100 times) photograph of a cross-section of the vibration damping and sound absorbing foam according to the present disclosure. In FIG. 2, it is found that fine particles larger than the cell diameters of the foam are contained in the cells.

The foamed cells 1b in the foam 1 that are illustrated in FIG. 1 include foamed cells forming bell-like structures containing the fine particles 2, and foamed cells that do not contain the fine particles 2. However, all of the foamed cells are formed by foaming of the foam 1 itself. In addition, as illustrated in FIG. 1, the foamed cells 1b that contain the fine particles 2 are configured to communicate (have communication paths) to the foam surface 1a. Patterns of the communication of the foamed cells 1b to the foam surface 1a include: (1) a case in which the foamed cells 1b are directly connected to the foam surface 1a; (2) a case in which the foamed cells 1b are linked to each other to be connected to the foam surface 1a; and (3) a case in which the communication paths are formed by repeatedly compressing the foam 1 to connect the cells to each other, or by blowing air against the foam surface 1a to crush the foam. The formation of the bell-like structures is achieved by inserting the fine particles 2 into the foamed cells 1b. In addition, it is desired to prepare, as the foam 1, foam in which the foamed cells 1b are uniform and which has communication paths to the foamed cells 1b on the foam surface 1a. The expression “foamed cells are uniform” as used in the present disclosure is intended to encompass not only a case in which the foamed cells include only foamed cells of completely identical dimensions, but also a case in which the foamed cells have a single peak in a histogram of their cell diameters.

In addition, the bell-like structures as illustrated in FIG. 1 enhance a vibration damping effect by exhibiting a vibration damping effect based on vibration and collision of the fine particles 2 in the bell-like structures (impact damper effect), and a vibration damping effect based on the deformation of the foam 1 caused by the weight of the fine particles 2 (mass damper effect). Further, the foamed cells 1b in the bell-like structures communicate to the surface of the foam 1, and hence a sound absorbing effect is also enhanced.

From the viewpoint of taking both of a vibration countermeasure and a sound countermeasure, a weight ratio between the foam 1 and the fine particles 2 in the vibration damping and sound absorbing foam according to the present disclosure is preferably as follows: weight of the fine particles 2/weight of the foam 1=0.1 to 200. In addition, from the above-mentioned viewpoint, the cell diameter of each of the foamed cells 1b is preferably from 50 μm to 2,000 μm, and more preferably falls within the range of from 100 μm to 800 μm. The foamed cell diameter is determined by sampling about 20 largest foamed cells and calculating an average value therefor. For each of oval foamed cells, a value obtained by dividing the sum of its longest diameter and shortest diameter by 2 is used in the calculation.

Next, the steps in the method of producing vibration damping and sound absorbing foam of the present disclosure are described one by one.

<Step [I]>

The step [I] is a step of preparing foam having foamed cells present inside the foam and having communication paths to the foamed cells on a surface thereof, and fine particles each having a particle diameter smaller than a cell diameter of each of the foamed cells and larger than a diameter of each of the communication paths.

As a polymer material for the foam, there are given, for example, polyether urethane, polyester urethane, a natural rubber, a chloroprene rubber, an ethylene propylene rubber, a nitrile rubber, a silicone rubber, a styrene butadiene rubber, polystyrene, polyolefin, a phenol resin, polyvinyl chloride, a urea resin, polyimide, and a melamine resin. Those materials may be used alone or in combination thereof. Of those, ether polyurethane and ester polyurethane are preferably used from the following viewpoint: many communication paths to the surface of the foam can be formed, and hence vibration damping and sound absorbing foam for taking both of a vibration countermeasure and a sound countermeasure can be more satisfactorily produced.

When the polyurethane to be used has an NCO index of from 0.8 to 1.5, vibration damping and sound absorbing foam excellent in vibration damping and sound absorbing performance can be more satisfactorily produced.

For example, in the case of the polyurethane, a foaming agent, such as water, a chain extender, a catalyst, a foam stabilizer, a hydrolysis inhibitor, a flame retardant, a viscosity reducing agent, a stabilizer, a filler, a cross-linking agent, or a colorant is blended in the material for the foam as required in addition to a polyol component thereof and an isocyanate component thereof.

In addition, the foam is obtained by subjecting the material for the foam to kneading or the like, and subjecting the resultant to heating or the like. However, when mold forming is performed in the production of the foam, a skin layer is formed on the surface of the foam, and hence the openings of the communication paths to the foamed cells described above do not appear on the surface of the foam in some cases. In such cases, when air is blown against the surface of the foam to crush the foam, the openings of the communication paths to the bell-like structures are likely to appear on the surface of the foam, and hence the step [II] to be described later can be more favorably performed.

In addition, as described above, the foamed cell diameter of the foam is preferably from 50 μm to 2,000 μm, and more preferably falls within the range of from 100 μm to 800 μm. In the present disclosure, commercially available foam having such foamed cell diameter may be used.

In addition, the density of the foam is preferably from 10 kg/m³ to 500 kg/m³ from the viewpoints of a sound absorbing property and the ease of insertion of the particles, and is more preferably from 20 kg/m³ to 200 kg/m³ from similar viewpoints.

In addition, metal fine particles, resin fine particles, inorganic fine particles, and the like are used alone or in combination thereof as the fine particles each having a particle diameter smaller than the cell diameter of each of the foamed cells of the foam and larger than the diameter of each of the communication paths of the foam. As the metal fine particles, fine particles formed of iron, zinc, stainless steel, aluminum, copper, silver, or the like are used. As the resin fine particles, fine particles formed of polypropylene, polyethylene, acryl, urethane, polyamide (nylon), melamine, or the like, or fluorine resin fine particles or styrene rubber fine particles are used. As the inorganic fine particles, fine particles formed of glass, zircon, zirconia, silicon carbide, silica, magnesium oxide, calcium carbonate, or a metal oxide, such as titanium oxide or zinc oxide, are used. As other fine particles, plant fine particles, such as a walnut shell pulverized product, are used. Of those fine particles, fine particles formed of stainless steel and glass beads are preferred from the viewpoints of rust resistance and high specific gravity.

In addition, from the viewpoint of vibration damping and sound absorbing property, the specific gravity of the fine particles is preferably from 0.9 to 12, more preferably from 2 to 8. Further, from the viewpoint of vibration damping and sound absorbing property, the particle diameter of each of the fine particles is preferably from 10 μm to 2,000 μm, more preferably from 100 μm to 800 μm. The particle diameter refers to a median diameter according to Particle size analysis-Laser diffraction methods (JIS Z 8825). In addition, the particle diameters of particles used in Examples to be described later were also measured by a similar technique.

<Step [II]>

The step [II] is a step including swelling the foam with at least one liquid selected from water and a solvent to enlarge the diameter of each of the communication paths so that the diameter of each of the communication paths becomes larger than the particle diameter of each of the fine particles, and then sprinkling the surface of the foam with the fine particles, followed by pushing of the fine particles into the foamed cells via the communication paths through use of a fluid pressure of at least one liquid selected from water and a solvent. In performing this step, it is required to select such a combination of foam and fine particles that the fine particles are not allowed to enter the inside of the foam before the swelling of the foam, and the fine particles are allowed to enter the inside of the foam after the swelling of the foam.

Examples of the solvent include: hydrocarbon solvents, such as cyclohexane, normal hexane, toluene, and xylene; alcohol solvents, such as methanol, ethanol, isopropyl alcohol, butanol, and cyclohexanol; ketone solvents, such as acetone, methyl ethyl ketone, methyl isobutyl ketone, and cyclohexanone; ester solvents, such as ethyl acetate, butyl acetate, isobutyl acetate, amyl acetate, propylene glycol monoethyl ether acetate, and ethylene glycol monoethyl ether acetate; ether solvents, such as propylene glycol monomethyl ether, cellosolve, butyl cellosolve, and tetrahydrofuran (THF); and amide solvents, such as dimethylformamide. Those solvents may be used alone or in combination thereof. Of those, when a solvent having a boiling point of 150° C. or less (e.g., acetone or ethanol) is used as the liquid, the swelling and drying of the foam are facilitated, and hence vibration damping and sound absorbing foam for taking both of a vibration countermeasure and a sound countermeasure can be more satisfactorily produced.

The step [II] may be performed, for example, in such an apparatus as illustrated in FIG. 3. That is, foam X that is the aforementioned foam is immersed in a swelling solvent Y to be swollen, and then the surface of the foam X in the swelling solvent Y is sprinkled with fine particles Z. After that, the liquid and fine particles Z are poured with a syringe V. That is, when the pouring is performed as described above, the fine particles Z can be pushed into the foamed cells of the foam X through use of the fluid pressure of the liquid.

<Step [III]>

The step [III] is a step of drying the foam. When the foam is dried as described above, the communication paths that have been caused to have enlarged diameters in a swollen state are reduced in diameter to prevent the fine particles pushed into the foamed cells of the foam from exiting the foam. As a result, the vibration damping and sound absorbing foam of interest can be obtained (see FIG. 1).

From the viewpoint of sound absorption efficiency, the volume of the fine particles included in the vibration damping and sound absorbing foam obtained as described above is preferably from 1% to 80% of the volume of the entirety of the vibration damping and sound absorbing foam, more preferably from 1% to 30% of the volume of the entirety of the vibration damping and sound absorbing foam.

In addition, the vibration damping and sound absorbing foam obtained as described above is suitably used as, for example, vibration damping and sound absorbing foam for housing, vibration damping and sound absorbing foam for an automobile, vibration damping and sound absorbing foam for Office Automation equipment, vibration damping and sound absorbing foam for a railroad, or vibration damping and sound absorbing foam for a road or a bridge.

### EXAMPLES

Next, Examples are described together with Comparative Example. However, the present disclosure is not limited to these Examples without departing from the gist of the present disclosure.

First, prior to Examples and Comparative Examples, the following materials were prepared.

[Polypropylene Particles]

CL2507 manufactured by Sumitomo Seika Chemicals Co., Ltd., particle diameter: 180 μm, specific gravity: 0.9

[Glass Beads]

SPL300 manufactured by Unitika Ltd., particle diameter: 300 μm, specific gravity: 2.5

[Spherical Stainless-Steel Particles]

SUS50B manufactured by Shintokogio, Ltd., particle diameter: 300 μm, specific gravity: 7.9

[Swelling Solvent]

Acetone

[Urethane Foam]

Soft urethane foam EOL manufactured by Achilles Corporation, density: 22 kg/m³

A cross-section of the urethane foam was observed with a scanning electron microscope (manufactured by Hitachi, Ltd., SEMEDX TYPE N, magnification: 100 times). As a result, it was found that the urethane foam was in a uniformly foamed state. Further, a scanning electron microscope photograph was taken of the cross-section of the urethane foam, the 20 largest foamed cells were sampled, and an average value therefor was calculated to find that the foamed cell diameter was from 400 μm to 500 μm. For each of oval foamed cells, a value obtained by dividing the sum of its longest diameter and shortest diameter by 2 was used in the calculation.

### Example 1

In such an apparatus as illustrated in FIG. 3, the urethane foam (dimensions: 40 mm×160 mm×15 mm thick, 2.1 g) (foam X) was immersed in acetone (swelling solvent Y) to be swollen, and then the surface of the urethane foam in the acetone was sprinkled with the polypropylene particles (fine particles Z). After that, the acetone and the polypropylene particles were poured with a syringe (syringe V) to push the polypropylene particles into the foamed cells of the urethane foam through use of the fluid pressure of the acetone. After that, the urethane foam having been removed from the acetone was subjected to heat treatment at 60° C. for 12 hours to volatilize acetone in the urethane foam. The resultant was used as a sample. On the basis of the weight of the sample and the weight of the urethane foam used as a material therefor, the weight of the polypropylene particles in the sample was found to be 60 g. In addition, the volume of the polypropylene particles included in the sample was 6.67% of the entirety of the sample.

### Example 2

A sample was obtained in the same manner as in Example 1 except that the glass beads were used in place of the polypropylene particles. On the basis of the weight of the sample and the weight of the urethane foam used as a material therefor, the weight of the glass beads in the sample was found to be 100 g. In addition, the volume of the glass beads included in the sample was 4% of the entirety of the sample.

### Example 3

A sample was obtained in the same manner as in Example 1 except that the spherical stainless-steel particles were used in place of the polypropylene particles. On the basis of the weight of the sample and the weight of the urethane foam used as a material therefor, the weight of the spherical stainless-steel particles in the sample was found to be 180 g. In addition, the volume of the spherical stainless-steel particles included in the sample was 2.28% of the entirety of the sample.

### Comparative Example 1

The urethane foam (dimensions: 40 mm×160 mm×15 mm thick, 2.1 g) itself was used as a sample of Comparative Example 1.

Each of the thus obtained samples of Examples and Comparative Example was evaluated for its properties in accordance with the following criteria. The results are shown together in Table 1 below.

<<vibration Amount>>

One end of an iron plate measuring 40 mm×220 mm×1.2 mm thick was fixed, and a commercially available accelerometer was attached to the unfixed side thereof. Then, the sample was bonded to the iron plate. After that, the iron plate was hammered so that a constant force was applied thereto, and a vibration amount (dB) was measured when the vibration frequency of the accelerometer was 400 Hz or 800 Hz.

<<Sound Absorption Coefficient>>

The sample was punched into a cylindrical shape having a diameter of 30 mm and a thickness of 20 mm, and the resultant was subjected to the measurement of sound absorption coefficients (%) at 500 Hz, 1,000 Hz, and 2,000 Hz in conformity with JIS A 1405 (2007).

TABLE 1

| | | | Comparative | Exam- | Exam- | Exam- |
|---|---|---|---|---|---|---|
| | | | Example 1 | ple 1 | ple 2 | ple 3 |
| Vibration | 400 | Hz | 56 | 45 | 39 | 31 |
| amount (dB) | 800 | Hz | 52 | 43 | 41 | 37 |
| Sound | 500 | Hz | 11% | 12% | 11% | 11% |
| absorption | 1,000 | Hz | 18% | 23% | 19% | 19% |
| coefficient | 2,000 | Hz | 35% | 64% | 40% | 36% |

As apparent from the results of Table 1, the samples of the Examples have lower vibration amounts and higher sound absorption coefficients as compared to the sample of Comparative Example 1. Thus, the samples of the Examples are found to be capable of taking a countermeasure against sounds ranging widely from a low frequency to a high frequency. Herein, vibration and sound were separately measured, and there was no significant difference in sound absorption coefficient at 500 Hz between each of the samples of the Examples and the sample of Comparative Example 1. However, it has been actually confirmed that the configuration of each of the Examples can achieve a sound countermeasure at 500 Hz by a vibration countermeasure.

A cross-section of one of the samples of the Examples was observed with a scanning electron microscope (manufactured by Hitachi, Ltd., SEMEDX TYPE N, magnification: 100 times), and as a result, many bell-like structures were found in the foam (see FIG. 2). In addition, it was confirmed that the bell-like structures communicated toward the surface of the sample.

Although specific embodiments of the present disclosure have been described in Examples above, Examples are for illustrative purposes only and are not to be construed as limitative. It is intended that various modifications apparent to a person skilled in the art fall within the scope of the present disclosure.

The method of producing vibration damping and sound absorbing foam of the present disclosure is suitable as a method of producing vibration damping and sound absorbing foam to be used as, for example, vibration damping and sound absorbing foam for housing, vibration damping and sound absorbing foam for an automobile, vibration damping and sound absorbing foam for Office Automation equipment, vibration damping and sound absorbing foam for a railroad, or vibration damping and sound absorbing foam for a road or a bridge.

### REFERENCE SIGNS LIST

1 foam
1a foam surface
1b foamed cell
2 fine particle

1. A method of producing vibration damping and sound absorbing foam comprising foam and fine particles present inside the foam, so as to form bell-like structures having communication paths to a surface of the foam, the method comprising the following steps [I] to [III] in the stated order:
[I] a step of preparing
foam having foamed cells present inside the foam and having communication paths to the foamed cells on a surface of the foam, and
fine particles, each having a particle diameter smaller than a cell diameter of each of the foamed cells and larger than a diameter of each of the communication paths;
[II] a step including swelling the foam with at least one liquid selected from the group consisting of water and a solvent, to enlarge the diameter of each of the communication paths so that the diameter of each of the communication paths becomes larger than the particle diameter of each of the fine particles, and then sprinkling the surface of the foam with the fine particles, followed by pushing of the fine particles into the foamed cells via the communication paths with a fluid pressure of the at least one liquid selected from the group consisting of the water and the solvent; and
[III] a step of drying the foam.

2. The method of producing vibration damping and sound absorbing foam according to claim 1, wherein a material for the foam comprises at least one material selected from the group consisting of ether polyurethane and ester polyurethane.

3. The method of producing vibration damping and sound absorbing foam according to claim 1, wherein the fine particles comprise at least one selected from the group consisting of inorganic fine particles, metal fine particles, and resin fine particles.

4. The method of producing vibration damping and sound absorbing foam according to claim 1, wherein the liquid comprises a solvent having a boiling point of 150° C. or less.

5. The method of producing vibration damping and sound absorbing foam according to claim 1, further comprising, before the step [I], a step of blowing air against the surface of the foam to crush the foam.
